(19) United States
(12) Patent Application Publication
(10) Pub. No.: US 2002/0100158 A1
(43) Pub. Date: Aug. 1, 2002

(54) Method and system for efficient assembly of automotive components

(76) Inventors: Joseph F. Lak SR., Mequon, WI (US); John M. Kell, Linton (GB)

Correspondence Address: Oppenheimer Wolff & Donnelly LLP, 45 South Seventh Street, Suite 3300, Minneapolis, MN, 55402-1609, US

(21) Appl. No.: 09/770,597

(22) Filed: Jan. 26, 2001

(51) Int. Cl. B23P 11/00; B23P 21/00

(52) U.S. Cl. 29/430; 29/701; 29/822

(57) ABSTRACT

A manufacturing system and method utilizing a manufacturing cell having at least one workstation wherein a plurality of manufacturing processes may be performed by automated machinery and manual labor alike. A rotatable trunnion, mounted on a carriage, is operably associated with each workstation. The trunnion is capable of rotating a backbone, constructed and arranged to support a workpiece attached thereto. The carriage assembly translates the trunnion between a first position, outside of the workstation, and a second position, inside of the workstation.

### BACKGROUND OF THE INVENTION

The present invention pertains generally to a method and system for handling and transporting various workpieces used in the manufacture of automotive components. More specifically, the invention provides a system for presenting workpieces to manufacturing cells having workstations in which automated and/or manual work is done on the workpieces, thereby creating components. Further, the system allows for the removing of components from one workstation of the cell and, if necessary, conducting additional work on the components in another workstation of the cell.

Modern assembly line processes are typically similar to those first envisioned by Henry Ford except that many steps are performed by automated machinery. The workpiece still travels along a production line (e.g. a relatively linear path, or a path having operative linear components joined together with bends). Along this line, multiple stations exist to receive the workpiece and perform unique work steps at each stop.

Automation has improved the assembly line manufacturing process by providing increased speed, fewer breaks, increased uniformity, and tighter tolerances. However, automation has created many disadvantages to the production line method of assembly. These disadvantages can be loosely grouped into three interrelated categories: increased work in process, increased setup and overhead costs, and decreased production flexibility.

Increased Work in Progress

Automated assembly lines are often characterized by unacceptable levels of work in process. Work in process can be defined as workpieces which are in the assembly process but are not being worked on in the workstations, either because they are travelling between them, being oriented so that they may be worked on, or simply stock piled while waiting to be presented to a workstation.

The work in process can accurately be described as an inefficiency cost. Ideally, every inch of a manufacturing facility is occupied by workpieces which are being transformed into more valuable components at all times. Such a plant would represent perfect efficiency. Thus, the mere existence of a workpiece not undergoing a “value added” step is an inefficiency cost incurred by the manufacturer. This is especially true when robots and the like are performing dynamic positioning steps on the workpiece where no value is added. These steps require robot time, electricity, and space.

Spaced apart workstations contribute to work in process as the workpieces must travel the distances between the stations without having work done to them. Nonetheless, automated workstations positioned along an assembly line tend to be spaced apart because automated machines require a workpiece to be presented in a precise, predetermined location and at a precise, predetermined geometry to the automated tool. This is accomplished through the use of numerous orientation steps and various fixturing maneuvers. The workstations are thus spaced apart from each other to make room for complicated robotic systems to take a component exiting the preceding workstation, and perform numerous orientation steps on the component so that it is ready to be worked on by the succeeding workstation. It is not uncommon for a production line to have more robots performing orientation steps than actual work steps.

Workstations may also be spaced apart due to the layout of the manufacturing line. More specifically, bends and turns in a manufacturing line increase the travel distances between workstations. The old adage, “the shortest distance between two points is a straight line” applies. However, even though a production line is ideally constructed in a straight line, building space constraints often require bends in the line, thereby increasing work in process.

Additionally, an assembly line inherently creates work in process by virtue of its arrangement. Assembly lines can be thought of as a flow system comprising a plurality of workstations connected in series. The flow of work is, therefore, limited by the slowest workstation. In order to prevent a backlog of work, the assembly line must be timed to accommodate the slowest workstation. If it is desired to increase the flow of work, more than one of these slow workstations may be connected in parallel. For example, if two of the slowest types of workstations are connected in parallel, the flow of work through these workstations is doubled and, it is likely that a different workstation will become the slowest workstation. However, it is extremely expensive to branch a production line into two production lines to accommodate two such workstations connected in parallel. Therefore, the flow of work is slowed down to accommodate the slowest workstation and, work in process is increased as workpieces wait on the production line for the slowest workstation.

Workstations aligned in series also create work in process whenever problems encountered in the line result in the line stopping temporarily. Relatively small problems causing an entire line to stop is an inherent problem when workstations are connected in series. For instance, anytime a tool fails, the entire line must stop while the tool is replaced because there is no alternative path for the workpieces to follow.

Similarly, a series alignment inhibits the ability of a production line to allow obtaining real time feedback on part tolerances. Because it is undesirable to stop the production line in order to measure the dimensions of a component, feedback on part tolerances is obtained by sampling the output of a production line. If it is discovered that parts are out of tolerance, the production line is stopped and corrected. This results in costs associated with stopping the production line, and also costs associated with the parts that were produced which are out of tolerance. If it were possible to obtain real time feedback, production could be stopped as soon as one part were made out of specifications, so that corrective actions could be taken. This would decrease the number of defective parts produced.

Increased Setup and Overhead Costs

Though many costs have been reduced due to the increased speed, fewer breaks, increased uniformity, and tighter tolerances brought about by automating a production line, setup and overhead costs have increased.

Setup costs associated with automated production lines are largely attributable to planning, robotic machinery and programming. Production line planning is a significant endeavor usually involving teams of engineers. Careful calculations must be made using sophisticated statistical analysis in order to predict flow rate, tool failure occurrence, and optimal line layout. The complexity of production line planning is largely due to the series relationship of the various workstations. Each station is dependent on the performance of all of the other stations.

Robot costs are a very big setup cost. Once the line has been planned, and the number of required robots determined, it is typical practice to use only new robots on a new production line. Because the costs associated with stopping a production line are so significant, it is rare to equip a production line with used robots, even if they have significant useful life remaining. Once a production line has served its useful life, the robots are scrapped.

Typically, a large number of these expensive robots are needed. Because a production line is based on the division of labor theory, each robot that actually does perform work is usually assigned to one specific task. Because each robot only performs one task, a significant number of robots are required to perform all of the necessary work steps. Moreover, many, if not most, of the robots on a typical automated line are used for orientation steps rather than actual work steps. Workpieces being manipulated by orientation robots are technically work in process. Reducing the number of orientation robots needed would significantly decrease the unit costs of the components produced by the manufacturing facility. Remaining setup costs associated with automated production lines include robot programming costs and the costs of purchasing and assembling a conveyor system.

Overhead costs associated with automated production lines include electricity, robot maintenance, and real estate, to name a few. Surprisingly, costs associated with manpower are also significant, even in the case of an automated production line. Automated production lines are rarely completely automated, in that numerous personnel are required to monitor the operation of the robots, inspect the production line output, and perform preventive and corrective maintenance. Robot maintenance personnel are highly skilled and predictably expensive. Moreover, it is not uncommon to have a complete workstation in which the result of production steps such as welding and other types ofjoinery are inspected and supplemental welding is performed manually, if necessary. Additionally, many of the orientation steps are performed manually because it is economical to do so, in that the robotic steps are too complicated to justify automating the workstep.

Decreased Production Flexibility

Production flexibility can be defined as the ability of a production facility to alter its production rate, produce small batches on an as needed basis, produce a variety of secondary components if necessary, and be used to efficiently produce a second primary component in large numbers after having been previously used to produce a first primary component in large numbers.

A disadvantage of production lines is that they are so expensive to set up, they are not economically feasible for use in making small batches of product. Additionally, they take up too much real estate to mothball and later restart from time to time as replacement parts are needed. As a result, a speculation must be made as to the quantity of spare parts that will be required before the production line is ended. The production line is then used to produce this quantity of spare parts before it is disassembled. These spare parts are then stockpiled until they are required. This type of stockpiling results in costs due to real estate, degradation of the stored materials, namely, oxidation, damage, and the material costs associated with those spare parts that are never used.

The size and inflexibility of an operable production line also results in increased shipping costs. Because production lines are extremely expensive, there is usually only one production line established for any given product. If a manufactured component is needed, an order is placed with that production line and the component is sent to the desired location. It is not possible, for instance, to make an extra part at an off-site production facility closer to where the part is needed.

Further inflexibility is associated with the inability to use a manufacturing assembly line to produce parts other than those the assembly line was designed to produce. Insofar as a production line is only able to make one product, if for some reason production of that one product needs to be temporarily stopped, the production line remains idle during this period. If, however, the production line could be used to produce other products, the production line would then be able to remain operating during a period of time where one product is stopped. The production line would simply be used to produce another product during this time.

Similarly, production lines are not easily able to be expanded or reduced to match market fluctuations. In other words, it is difficult to increase or decrease production. As described above, the flow rate of a production line is calculated to meet a speculated product demand and also to accommodate the slowest workstation. If the demand was speculated incorrectly or later increases or decreases, it is economically difficult, if not impossible, to alter the output of a production line. Inflexibility thus invariably results in increased costs.

It can, therefore, be seen that there is a need for a manufacturing method that reduces work in process.

More specifically, there is a need for a manufacturing method that reduces work in process by reducing the number of orientation steps between workstations.

There is also a need for a manufacturing system and method that reduces work in process by reducing the travel time between workstations.

There is still a further need for a manufacturing system and method that reduces work in process by reducing the number of workstations required to produce a given component.

It can also be seen that there is a need for a manufacturing system and method that reduces production costs by reducing the number of robots required to create a given component.

There is also a need for a manufacturing system and method that reduces production costs by decreasing the cost associated with work in process such as stored space, storage damage such as oxidation and compression damage, stacking and retrieval costs, and the like.

There is an additional need for a manufacturing system and method that reduces production costs by allowing robots to be used for their entire useful lives, even if the product line changes or terminates.

There is yet a further need for a manufacturing system and method that reduces production costs by decreasing the impact of tool or machine malfunction on the total output of the manufacturing system.

It can also be seen that there is a need for a manufacturing system and method that allows a component to be quickly and efficiently produced at an off site location in small quantities.

Additionally, there is a need for a system and method of manufacturing that provides real time feedback on part dimensioning and tolerances.

There is finally a need for a system and method of manufacturing which can be expanded or reduced to respond to demand increases and decreases.

### SUMMARY OF THE INVENTION

The present invention, therefore, pertains to a manufacturing method and system which overcomes the problems of the prior art and meets the needs described above. Generally, an apparatus and automated method for handling, and performing work on, workpieces or subassemblies as they undergo an assembly process is provided.

In a preferred form, the present invention provides a flexible manufacturing cell in which a component may be manufactured. The manufacturing cell of the present invention is capable of replacing a production line. The manufacturing cell may comprise one or more workstations, each containing one or more robots and/or tooling for use by workers. Each robot preferably performs more than one function.

The manufacturing system of the present invention includes a unique part handling system for presenting workpieces to the robots and workers in each workstation. The part handling system generally comprises a backbone, indexable by a trunnion, a carriage assembly, a guidance system, and a movement facilitator.

A support assembly or backbone is constructed and arranged to be removably attachable to trunnion, described in more detail below. The backbone supports the workpiece in such a manner as to allow the workpiece to be accessible to the automated machines or workers in the manufacturing cell.

This backbone comprises a first end and a second end opposite the first end. The ends are constructed and arranged to be attachable to the operative components of the trunnion. More specifically, the ends are constructed and arranged to be attachable to mounting plates on the trunnion.

The backbone ends may include end plates having holes which match holes in the mounting plates, thereby facilitating quick attachment and release of the backbone to the trunnion.

At least one, preferably two, support members connect the first end and the second end of the backbone and have surfaces constructed and arranged to support a plurality of fixtures capable of holding a workpiece. In addition to the support members spanning between the end plates, it is preferable that the backbone include a keel which is operably attached to and spanning between the end plates. The keel provides rigidity to the backbone. Furthermore, a plurality of ribs are provided, which rigidly connect the keel to the support members.

A rigid design allows a variety of workpieces to be carried and presented by the backbone to the various machines of the manufacturing cells in a consistent, predictable, repeatable manner without the weight of the workpiece taking the position of the backbone out of specification or tolerance.

An electrical power web is provided and runs along the various components of the backbone. The web includes a jack, attachable to a power supply, and a power cable network stemming from the jack. The cables branch out and have a plurality of connections attachable to the fixtures for providing power thereto.

A digital information network, attached to the backbone, sends digital instructions to the various fixtures supported by the backbone. It is envisioned that he digital information network include a jack, which is attachable to a digital communications line supplying the instructions, and a plurality of connections extending from and in digital communication flow with the jack. The connections are attachable to the fixtures, which are capable of receiving digital commands and responding to them. It is further envisioned that it may be advantageous to provide a single, dual-purpose integral jack housing both the electrical power jack and the digital information line jack.

A trunnion carries and indexes the backbone to present the workpiece to the tools, machines, and workers in a given manufacturing cell. The trunnion has a first rotatable mounting plate and a second rotatable mounting plate which is longitudinally displaced from the first mounting plate along the axis of rotation. The mounting plates are constructed and arranged to accept a backbone therebetween. One of the mounting plates is operably connected to a rotating drive mechanism which is capable of indexing the workpiece to a plurality of angular positions, thereby optimizing the presentation of the workpiece to the machines. Preferably, for ease of construction, one of the mounting plates is not operably connected to the drive mechanism and is allowed to rotate freely.

A carriage assembly is provided for allowing the trunnion to be moved into and out of a workstation of a manufacturing cell. The carriage assembly comprises a carriage and a guidance system. The trunnion is mounted on the carriage which is moveable between a first position outside of the workstation and a second position inside of the workstation. The guidance system minimizes or eliminates unwanted movement transverse to the preferred travel path of the carriage. In an envisioned embodiment, the guidance system comprises a railway or similar transverse-limiting path arrangement on which the carriage may ride between the first and second positions. The carriage assembly is constructed and arranged to ensure that the trunnion can repeatably achieve the second position within a predetermined tolerance.

Though any movement facilitator may be operably attached to the carriage or guidance system, it is preferred that the carriage is equipped with wheels constructed and arranged to ride and follow guidance system rails. Alternatively, the guidance system may have wheels rotatably and operably attached thereto on which gliding members operably attached to the carriage may ride.

It is to be understood that once the trunnion is mounted on a moveable carriage that the trunnion and the carriage can be treated as one component and that, inasmuch as the carriage may attain a first position outside of the workstation and a second position inside of the workstation, the trunnion can also be said to achieve said first position outside of the workstation and said second position inside of the workstation. Though it is understood that the trunnion and the carriage are not in the exact same position, they are fixed relative to each other and for purposes of convention as used herein the carriage positions and the trunnion positions are one and the same.

Having briefly summarized the preferred physical embodiments of the present invention, it is now possible to provide a summary of the preferred manufacturing methods of the present invention.

The method includes providing the components of a manufacturing cell, as described briefly above and in more detail below. A carriage and trunnion is moved to a first position located outside of the manufacturing workstation. A backbone is supported by the trunnion and has fixtures to which a workpiece is then attached. The trunnion is indexed such that the backbone presents the workpiece at a predetermined orientation to the machinery of a workstation. The carriage is moved to the second position, within the workstation, where a manufacturing process is performed on the workpiece using the machinery in the workstation. It is understood that the trunnion may be indexed after the carriage is moved to the second position.

These and further objects and advantages of the present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a perspective view of a manufacturing facility incorporating the teachings of the present invention;

FIG. 2 is a perspective view of a backbone of the present invention; and,

FIG. 3 is a perspective view of a preferred embodiment of a trunnion and a carriage assembly of the present invention.

All figures are drawn for ease of explanation of the basic teachings of the preferred embodiments only. The extensions of the Figures with respect to number, position, relationship, and dimensions of the parts to form the preferred embodiments will be explained or will be within the skill of the art after the following description has been read and understood. Further, the exact dimensional proportions to conform to the specific force, weight, strength, and similar requirements will likewise be within the skill of the art after the following description has been read and understood.

Where used in the various figures of the drawings, the same numerals designate the same or similar parts. Furthermore, when the terms “top”, “bottom”, “upper”, “lower”, “first”, “second”, “front”, “rear”, “end”, “edge”, “forward”, “rearward”, “upward”, “downward”, “inward”, “outward”, “inside”, “side”, “longitudinal”, “lateral”, “horizontal”, “vertical”, and similar terms are used herein, it should be understood that these terms have reference only to the structure shown in the drawings as it would appear to a person viewing the drawings and are utilized only to facilitate describing the preferred embodiments.

### DETAILED DESCRIPTION OF PREFERRED EMBODIMENTS

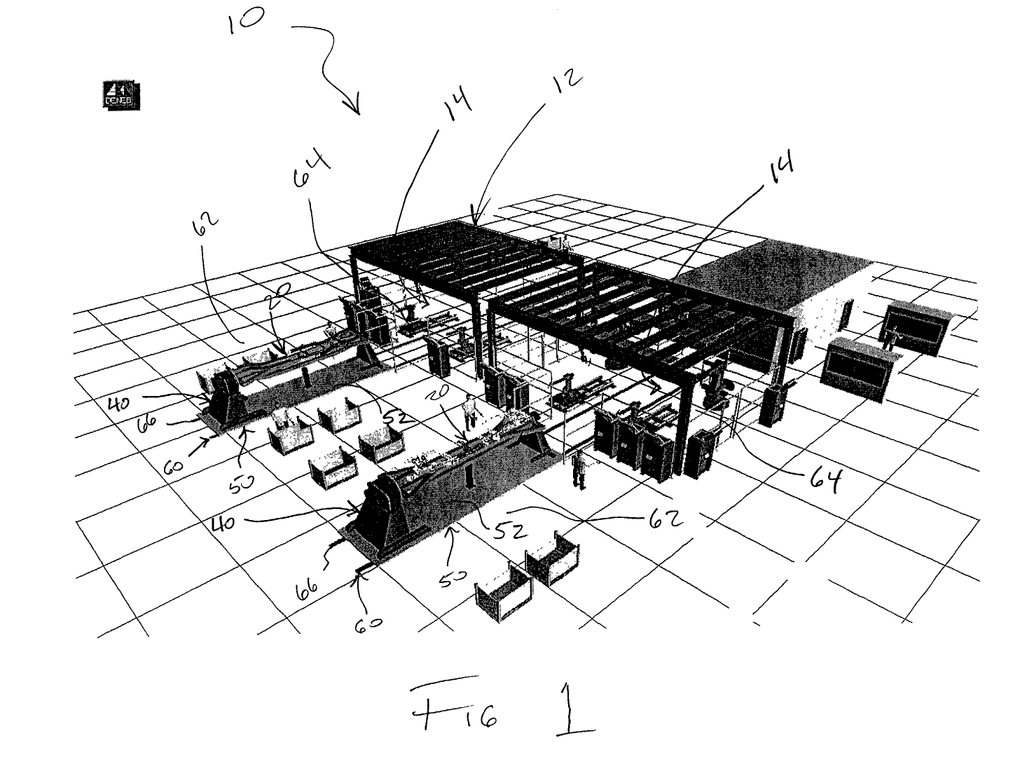

Referring now to the Figures and first to FIG. 1 there is shown a manufacturing facility 10 incorporating the preferred embodiments of the present invention. Generally, a plurality of manufacturing cells 12 are provided, each having at least one workstation 14 in which manufacturing processes take place by various machines, tools and operators.

The workpieces are held in place for work thereon in the workstations 14 by backbones 20. Preferably, the backbones 20 are quickly and easily removable and attachable to trunnions 40.

The trunnions 40 are indexing devices used to hold and rotate the backbones 20. The trunnions 40 rotate, or index, the backbones 20 such that the workpieces may be presented to the machines in a workstation 14 at a predetermined, desired angle.

The ingress and egress of workpieces into and out of the workstations 14 is enabled using carriage assemblies 50 having carriages 52 and guidance systems 60. The carriages 52 are constructed and arrange to the move trunnions 40 between a first position 62 outside of the workstation 14 and a second position 64 inside of the workstation 14. The guidance systems 60 allow the carriages 52 to achieve the first position 62 and the second position 64 with a predetermined level of accuracy.

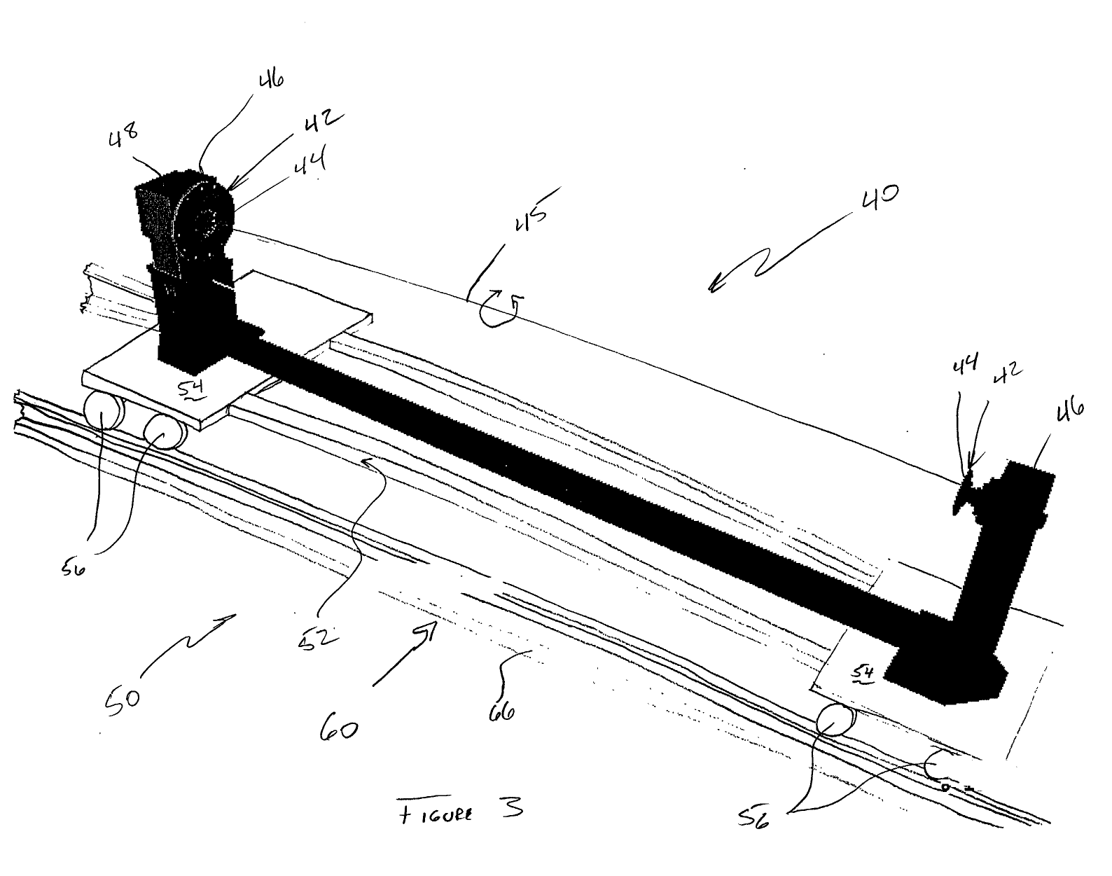

Preferably, the backbones 20 are quickly and easily removable and attachable to the operable components 42 (FIG. 3) of the trunnions 40.

Each of these general components, and the preferred embodiments of the manufacturing processes of the present invention, are described individually in more detail below.

Backbone

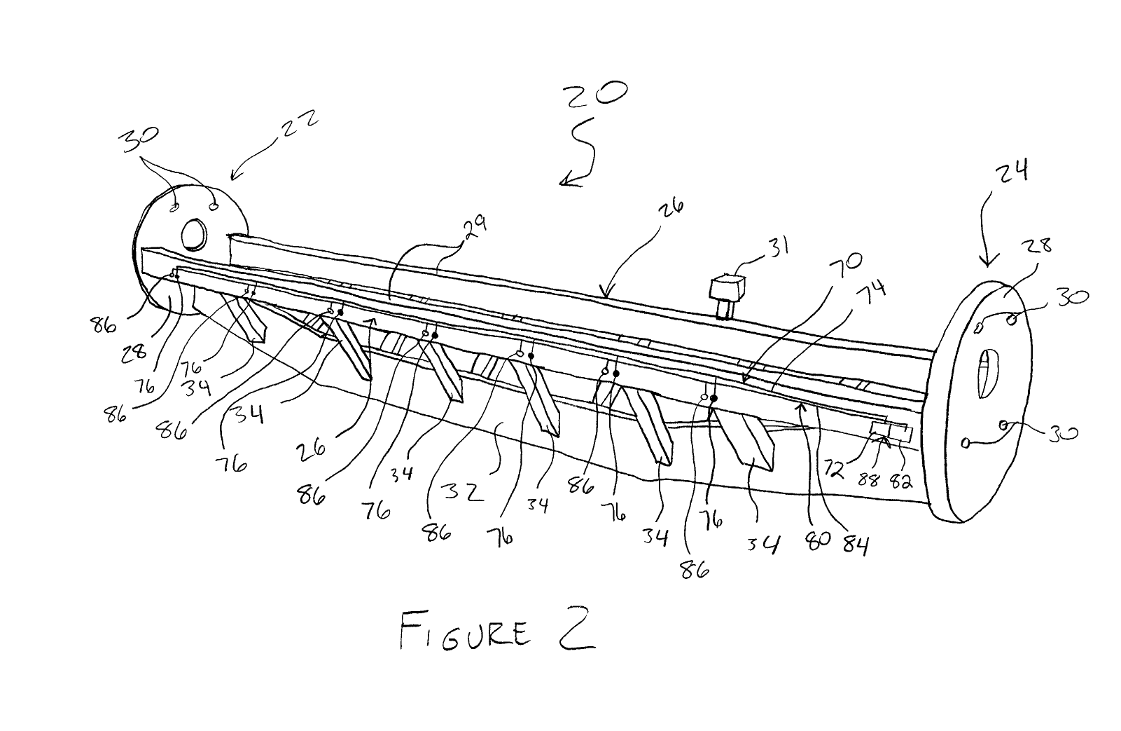

FIG. 2 shows a preferred embodiment of the backbone 20 of the present invention. The backbone 20 generally comprises a first end 22 separated from a second end 24 by at least one support member 26. Preferably, the first end 22 and the second end 24 comprise plates 28 which define a plurality of holes 30 to be used to attach the backbone 20 to the trunnion 40. It will be seen below that the trunnion 40 has operative components 42 to which an object may be attached and it is preferable that the plates 28 are constructed and arranged to match or mate with the operative components 42.

Preferably, more than one support member 26 is provided. The support members 26 span from the first end 22 to the second end 24 and provide surfaces 29 to which backbone fixtures 31 may be mounted. The backbone fixtures 31 may be general purpose clamping devices, specially designed tools for handling a specific workpiece, or any holding, moving, or small piece of machinery that could be useful if mounted to the backbone 20. It is envisioned that many fixtures 31 will be capable of receiving and responding to digital signals, providing digital feedback, and may require electrical, hydraulic, or pneumatic power.

A keel 32 is also preferably provided and spans completely or partially between the ends 22 and 24. The keel 32 adds rigidity to the backbone 20 which is important to ensure accurate presentation of a workpiece to the machinery of a workstation 14, regardless of the weight of the workpiece. Additionally, a preferred embodiment of the present invention adds a plurality of ribs 34 connected between the keel 32 and the support members 26. The ribs 34 add further rigidity to the backbone 20.

The preferred backbone shown in FIG. 2 also provides a digital information network 70 used to send and receive digital information to and from the fixtures 31. The digital information network 70 preferably includes a digital jack 72 operably attached to a digital communications line 74. A plurality of digital connections 76, stemming from the digital communications line 74 and in digital communications flow with the digital jack 72, are attachable to the fixtures 31 and/or in digital communications flow therewith. It is envisioned that the fixtures 31 are not only able to respond to the digital command signals received through the digital information network 70, but that they are preferably able to send data back through the network 70 as to their precise positions. This provides real time feedback as to the specific dimensions of the workpieces they are holding.

Additionally, an electrical power web 80 is preferably provided and operably attached to the backbone 20. The electrical power web 80 includes an electrical jack 82, attachable to an outside power supply. An electrical cable network 84 stems from the electrical jack 72 and has a plurality of electrical connections 86 operably attached thereto. The electrical connections 86 are connectable to the electrically powered fixtures 31.

Alternately or additionally, other forms of power (not shown in the Figures) may be provided to the fixtures 31. For example, it is envisioned that backbone also include a pneumatic gas network, attached to backbone, and having a gas coupling connectable to a pneumatic pressure supply line. Like the electrical and digital networks, a pneumatic gas conduit stems from said gas coupling and ends in a plurality of pneumatic gas connections connectable with pneumatic gas couplings on said fixtures.

Similarly, a hydraulic fluid network may be attached to backbone, which includes two hydraulic fluid couplings, connectable to a pressurized hydraulic fluid supply line and a hydraulic fluid return line. A hydraulic fluid conduit stems from each of fluid couplings, and results in a plurality of hydraulic fluid supply and return connections, connectable with hydraulic couplings on fixtures.

It is envisioned that a single multi-purpose jack 88 may be provided which includes a digital communications jack 72 and any combination of the various power jacks described above, such as an electrical jack 82. Providing a multi-purpose jack 88 reduces the number of steps required to attach and remove a backbone 20 to and from a trunnion 40.

Trunnion

Referring now to FIG. 3, a trunnion 40 is provided and preferably associated with each manufacturing cell 12. The trunnion 40 generally comprises operable components 42 which preferably include opposing mounting plates 44. The operable components 42 rotate around an axis of rotation 45 and are attachable to a backbone 20. The operable components 42 are elevated by first and second towers 46, thereby allowing clearance for the rotating backbone 20 and a workpiece held thereon.

Preferably, a rotating drive mechanism 48 is operably attached to one of the operable components 42 and drives a mounting plate 44. The rotating drive mechanism 48 is constructed and arranged such that it is capable of accurately indexing a backbone 20 to various angles.

Carriage Assembly

FIG. 3 shows that a trunnion 40 is mounted on or otherwise moveable by a carriage assembly 50. The carriage assembly 50 generally includes a carriage 52 and a guidance system 60. The carriage 52 preferably comprises a platform 54, or mounting rails in the alternative, for supporting a trunnion 40, and a plurality of wheels 56 operably attached to the platform 54. The guidance system 60 is operably associated with the carriage 52 and guides the carriage 52 between the first position 62, outside of the workstation 14, and the second position 64, inside of the workstation 14, where work is performed on the workpiece. As shown in the Figures, it is envisioned that an acceptable configuration of a carriage assembly 50 provides a rail system 66 as the guidance system 60 with rail-following wheels 56 operably attached to the platform 54.

Manufacturing Cell

The manufacturing cell 12, seen in FIG. 1, is constructed and arranged for accepting a trunnion 40 carrying a backbone 20, and for performing work on a workpiece held thereon. The carriage 52 of the carriage assembly 50 travels to and stops at the second position 64 where work is then done to the workpiece. It is conceivable that the guidance system 60 allows the carriage 52 to pass completely through the manufacturing cell 12 such that ingress occurs on the opposite side of the cell 12 that egress occurs. It is important, however, that the carriage 52 be able to accurately assume the second position 64 in a repeatable manner.

The manufacturing cells 12 are outfitted with tooling and machinery based on the desired work to be performed in each cell 12. A determination is made as to an appropriate angle at which the backbone 20 should present a workpiece to the machinery of each workstation 14, for every work step, based on the work to be performed therein.

Preferably, a plurality of manufacturing cells 12, each having at least one workstation 14, are provided and consideration is given to the required manufacturing processes to be performed in each and the amount of time a workpiece will spend in each. It may be advantageous to provide more than one workstation 14 per cell 12 for performing lengthy processes and only one workstation 14 per cell 12 for faster operations. An envisioned layout of a cell 12 is seen in FIG. 1.

Method of Manufacturing

Having thus described the structural components of the preferred embodiments of the present invention, a preferred method of manufacturing is now detailed.

Structural components are provided, as described above. Generally, at least one manufacturing cell 12 is provided, each having at least one workstation 14. A trunnion 40 is also provided which is moveable between a first position 62 and a second position 64 via a carriage assembly 50 including a carriage 52 and a guidance system 60. A backbone 20 is provided which is constructed and arranged with fixturing 30 selected for appropriately handling the desired workpieces.

The carriage 52, operably attached to the trunnion 40, is moved to the first position 62, outside of the manufacturing cell 12, where the workpiece or workpieces are placed in the fixtures 31 which are operably attached to the support surfaces 29. The trunnion 40 then indexes the backbone 20 to an appropriate angle such that the workpieces are presented to the machinery in the workstation 14 at a predetermined orientation.

The carriage 52 is then moved to the second position 64, inside of the workstation 14. It is envisioned that indexing the backbone 20 could be accomplished after the carriage 52 is moved to the second position 64. Alternatively, to save time, the indexing could occur while the carriage 52 is moving from the first position 62 to the second position 64.

Once the carriage 52 has assumed the second position 64, work may begin on the workpiece. Though the manufacturing system herein described is suitable for performing a singular manufacturing process on a workpiece in a workstation 14, in order to achieve many of the advantages of the present invention, it is preferred to perform multiple manufacturing processes on the workpiece. It may be necessary to index the trunnion 40 between various steps of the manufacturing processes.

It is envisioned that it may be desirable to provide two or more workstations 14 in a manufacturing cell 12. For example, if an assembly to be produced in a manufacturing cell 12 requires a number of manufacturing processes to be performed on a workpiece before subassembly is combined with the workpiece to create the assembly, it may be preferable to place the workpiece on a support member 26 attached to a trunnion 40, move the trunnion to the second position 64 in a workstation 14, perform a plurality of manufacturing processes, move the trunnion 40 back to the first position 62, and then transfer the workpiece to a second trunnion 40 which is associated with a second workstation 14. The second workstation 14 could then be used in the manner described above to combine the workpiece with a subassembly and perform a plurality of subsequent processes in order to create a finished assembly or component.

Those skilled in the art will further appreciate that the present invention may be embodied in other specific forms without departing from the spirit or central attributes thereof. In that the foregoing description of the present invention discloses only exemplary embodiments thereof, it is to be understood that other variations are contemplated as being within the scope of the present invention.

An example of a variation on the described embodiments which would be considered within the scope of the present invention is, providing a trunnion in which both mounting plates are operably connected to the rotating drive mechanism. In this embodiment, it is important that both mounting plates be synchronized with each other.

Yet another example of a variation on the described embodiments which would be considered within the scope of the present invention is providing a guidance system which comprises a plurality of wheels constructed and arranged for travel thereon by a carriage having flat surfaces which roll along the wheels and guidance rollers which center the carriage on the guidance system. Alternatively, carriage assembly may include a carriage having motorized wheels and a guidance system which uses radar or another type of electronic guidance to send start, stop and steering commands to the wheels.

Accordingly, the present invention is not limited in the particular embodiments which have been described in detail therein. Rather, reference should be made to the appended claims as indicative of the scope and content of the present invention.

What is claimed is:

1. An elongate backbone, attachable to a trunnion, capable of supporting a truck frame, comprising:
a first end plate and a second end plate opposite said first end plate, said plates constructed and arranged to be attachable to a trunnion;
at least two support members operably attached to and spanning between said end plates, each of said members including a surface to which clamping fixtures may be attached;
a keel operably attached to and spanning between said end plates, said keel providing rigidity to said elongate backbone; and,
a plurality of ribs rigidly connecting said keel to said support members.

2. The backbone of claim 1 further comprising:
an electrical power web including an electrical jack which is connectable to a power supply, and an electrical cable network stemming from said electrical jack having a plurality of electrical connections connectable to electrically powered fixtures capable of holding a workpiece; and,
a digital information network including a digital jack which is connectable to a digital communications line, and a plurality of digital connections in digital communication flow with said digital jack and connectable to fixtures capable of holding a workpiece, and capable of receiving digital commands and responding thereto.

3. The backbone of claim 2 further comprising a dual-purpose integral jack housing said electrical power jack and said digital communications jack.

4. The backbone of claim 1 wherein said first end plate and said second end plate comprise
a plurality of holes, sized and arranged to generally match holes on mounting plates operably attached to the trunnion.

5. A backbone, attachable to a trunnion, for supporting and presenting a workpiece to automated machinery comprising:
a first end and a second end opposite said first end, said ends constructed and arranged to be attachable to operative components of the trunnion;
at least one support member connecting said first end and said second end and having surfaces constructed and arranged to support fixtures capable of holding a workpiece to said support member;
an electrical power web attached to said backbone, said web including an electrical jack connectable to a power supply, and a cable network stemming from said electrical jack and having a plurality of electrical connections connectable to electrically powered fixtures; and,
a digital information network including a digital jack, attachable to a digital communications line, and a plurality of digital connections in digital communication flow with said digital jack and attachable to fixtures capable of holding a workpiece, and capable of receiving digital commands and responding thereto.

6. The backbone of claim 5 wherein said ends comprise plates.

7. The backbone of claim 6 wherein said plates define a plurality of holes sized and arranged to match holes present on the operative components of the trunnion.

8. The backbone of claim 5 further comprising a dual purpose integral jack which houses said electrical power jack and said digital communications jack.

9. The backbone of claim 5 wherein said ends comprise shafts insertable into the operative components of the trunnion.

10. The backbone of claim 5 further comprising a keel spanning between said first end and said second end, thereby adding rigidity to said backbone.

11. The backbone of claim 10 further comprising a plurality of ribs connecting said keel with said support member, thereby preventing said support member from sagging when the workpiece is placed thereon.

12. The backbone of claim 5 further comprising a hydraulic fluid network attached to said backbone, said hydraulic fluid network including two hydraulic fluid couplings, connectable to a pressurized hydraulic fluid supply line and a hydraulic fluid return line, a hydraulic fluid conduit stemming from each of said fluid couplings, and a plurality of hydraulic fluid supply and return connections, connectable with hydraulic couplings on said fixtures.

13. The backbone of claim 5 further comprising a pneumatic gas network attached to said backbone, said pneumatic gas network including a gas coupling connectable to a pneumatic pressure supply line, a pneumatic gas conduit stemming from said gas coupling, and a plurality of pneumatic gas connections connectable with pneumatic gas couplings on said fixtures.

14. A manufacturing system comprising:
a manufacturing cell constructed and arranged to perform at least one manufacturing process on a workpiece therein;
a trunnion constructed and arranged to hold and rotate an object around a predetermined axis of rotation;
a carriage assembly having a carriage, operably supporting said trunnion, and a guidance system controlling movement of said carriage between a first position outside of said cell and a second position inside of said cell;
a backbone, removably attachable to said trunnion, having surfaces to which fixtures, constructed and arranged to fix a workpiece to said backbone, are attachable, said backbone rotatable around said axis of rotation by said trunnion when attached thereto.

15. The manufacturing system of claim 14 wherein said carriage assembly comprises wheels rotatably attached to said carriage.

16. The manufacturing system of claim 15 wherein said carriage comprises a motor operably attached to said wheels.

17. The manufacturing system of claim 15 wherein said wheels are constructed and arranged for riding on rails.

18. The manufacturing system of claim 17 wherein said guidance system comprises rails on which said carriage rides and is guided from said first position to said second position and from said second position to said first position.

19. The manufacturing system of claim 14 wherein said backbone comprises a first end and a second end opposite said first end, said ends constructed and arranged to be attachable to operative components of said trunnion.

20. The manufacturing system of claim 19 wherein said backbone further comprises at least one support member connecting said first end and said second end and defining said surfaces to which fixtures are attachable.

21. The manufacturing system of claim 14 wherein said backbone comprises an electrical power web attached to said backbone, said web including an electrical jack connectable to a power supply, and a cable network stemming from said electrical jack and having a plurality of electrical connections connectable to electrically powered fixtures capable of holding a workpiece.

22. The manufacturing system of claim 14 wherein said backbone comprises a digital information network including a digital jack, attachable to a digital communications line, and a plurality of digital connections in digital communication flow with said digital jack and attachable to fixtures capable of holding a work piece, and capable of receiving digital commands and responding thereto.

23. The manufacturing system of claim 20 wherein said support member further comprises a keel spanning between said first end and said second end, thereby adding rigidity to said support member.

24. The manufacturing system of claim 23 wherein said backbone further comprises a plurality of ribs connecting said keel with said support member, thereby preventing said support member from sagging when the work piece is placed thereon.

25. A method of manufacturing comprising:
providing a manufacturing cell having at least one workstation constructed and arranged with machinery to perform at least one manufacturing process on a workpiece therein;
providing a trunnion having a rotating drive mechanism and at least two rotatable operative components, at least one of said operative components driven by said rotating drive mechanism;
providing a carriage assembly comprising a carriage and a guidance system, said carriage operably attached to said trunnion and moveable between a first position outside said cell and a second position inside said cell, said guidance system operably associated with said carriage and constructed and arranged to ensure said carriage can repeatably achieve said second position;
providing a backbone constructed and arranged to be removably attachable to said operative components of said trunnion and rotatable thereby so as to allow said trunnion to index said backbone in such a manner as to present the workpiece attached thereto at a predetermined orientation to said machinery;
providing a plurality of fixtures, operably attached to said backbone, capable of holding the workpiece to said backbone;
moving said carriage to said first position;
placing the workpiece in said fixtures, thereby attaching the workpiece to said backbone;
indexing said trunnion such that said backbone presents the workpiece at said predetermined orientation to said machinery;
moving said carriage to said second position within said manufacturing cell;
performing a first assembly process on the workpiece using said machinery in said manufacturing cell.

26. The method of manufacturing of claim 25 further comprising:
providing another manufacturing cell;
providing another, similar, trunnion and backbone moveable via an other carriage assembly operably attached to said other trunnion, between a first position outside said other manufacturing cell and a second position inside said other manufacturing cell, said other carriage assembly constructed and arranged to ensure said other trunnion can repeatably achieve said second position inside said other manufacturing cell within a predetermined tolerance, said other trunnion having a rotating drive mechanism and at least two operative components, at least one of said operative components rotatable by said rotating drive mechanism;
moving said other trunnion to said first position outside said other manufacturing cell if said other trunnion is at a position other than said first position outside said other manufacturing cell;
removing said workpiece from said first backbone after said first assembly process is complete;
attaching said workpiece to said other backbone;
indexing said other trunnion such that said backbone presents the workpiece at an other predetermined orientation to said machinery;
moving said other trunnion from said first position outside said other manufacturing cell to said second position inside said other manufacturing cell;
performing a next manufacturing process on said workpiece.

27. The method of manufacturing of claim 25 wherein providing a carriage assembly includes providing a carriage having a plurality of wheels rotatably attached thereto.

28. The method of manufacturing of claim 25 wherein providing a carriage assembly includes providing a guidance system having a plurality of wheels rotatably attached thereto.

29. The method of manufacturing of claim 27 wherein said wheels are constructed and arranged for riding on rails

30. The method of manufacturing of claim 29 wherein said system further comprises rails on which said carriages ride and are guided from said first position to said second position and from said second position to said first position.

31. The method of manufacturing of claim 25 further comprising providing a digital information network operably attached to said backbone and in digital communication flow with said fixtures, said network capable of being used to send commands to said fixtures and receive positional feedback from said fixtures.

32. The method of manufacturing of claim 26 wherein said other predetermined orientation is different than said predetermined orientation.
